(19) United States
(12) Patent Application Publication
(10) Pub. No.: US 2009/0033821 A1
(43) Pub. Date: Feb. 5, 2009

(54) OPTICALLY COMPENSATED BEND MODE LIQUID CRYSTAL DISPLAY DEVICES

(75) Inventors: Kuo-Chang Lee, Pingtung County (TW); Kuo-Lung Lo, Taipei County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, Hsinchu (TW)

(21) Appl. No.: 12/047,280

(22) Filed: Mar. 12, 2008

(30) Foreign Application Priority Data
Aug. 2, 2007 (TW) TW96128367

(51) Int. Cl. G02F 1/1333; G02F 1/13; G02F 1/1337

(52) U.S. Cl. 349/48; 349/123; 349/33; 349/126

(57) ABSTRACT

An OCB mode liquid crystal display device is provided. The OCB mode liquid crystal display device comprises a first substrate, a second substrate and a liquid crystal layer interposed therebetween. The first substrate and the second substrate are disposed oppositely to each other. The device further comprises a first pixel electrode disposed on the first substrate, a second pixel electrode disposed on the first substrate and spaced apart from the first pixel electrode by a distance. The first pixel electrode and second pixel electrode are alternately arranged. The device further comprises a first alignment layer disposed on the first substrate to cover the first pixel electrode and the second pixel electrode, a common electrode disposed on the second substrate, and a second alignment layer disposed on the second substrate covering the common electrode.

### BACKGROUND OF THE INVENTION

1. Field of the Invention

The present invention relates to liquid crystal display (LCD) devices and methods for manufacturing the same, and in particular relates to optically compensated bend (OCB) mode liquid crystal display devices and methods for manufacturing the same.

2. Description of the Related Art

Liquid crystal display (LCD) devices have many advantages such as a smaller volume, lighter weight and lower power consumption. Due to features of LCDs such as a lighter weight, thinner profile, and increased portability, LCDs are applicable in a variety of electronic and communication devices including notebook computers, personal digital assistants (PDA), mobile phones and the like.

Conventional LCDs have a relatively narrower viewing angle, thus limiting application fields. Multi-domain vertical alignment (MVA) LCDs have been proposed to increase viewing angle, in which bumps or protrusions are disposed on the substrate of an LCD so that the liquid crystal molecule orientation may be changed. With the lines of electric force changed in a liquid crystal cell, arrangement and tilt of liquid crystal molecules may be changed at the same time. However, a complex process, such as a photolithography process using a half-tone mask, is required to form the bumps or protrusions on the substrate.

OCB mode LCDs have also been proposed to compensate viewing angle by changing the arrangement of liquid crystal molecules so that the LCDs have a wider viewing angle and faster response time.

U.S. Pat. No. 6,853,435 discloses an OCB LCD having a wider viewing angle and faster response time. When turning on, however, display mode can be used only when the liquid crystal molecules transition from a splay state to bend state. It takes a few seconds or minutes to transition from a splay state to bend state. A protrusion is therefore added on the lower substrate to change the line of the electric force inside of the panel, thus significantly reducing the transition time.

FIG. 1 is a cross section of a conventional OCB mode liquid crystal display device. The conventional OCB mode liquid crystal display device 100 as shown in FIG. 1 includes a first substrate 108 and a second substrate 101 disposed oppositely to each other. The first substrate 108 and the second substrate 101 are spaced apart by spacers 105. A pixel electrode 107 is disposed on the first substrate 108 and a lower alignment layer 106 is disposed on the pixel electrode 107. A common electrode 102 is disposed on the second substrate 101 and an upper alignment 103 is disposed on the common electrode 102. A liquid crystal layer 104 is filled into the space between the first substrate 108 and the second substrate 101. In the conventional OCB mode liquid crystal display device 100, the line of electric force inside of the panel is changed by means of adding a protrusion 110. As a result, the transition time can be significantly reduced.

U.S. Pat. No. 6,535,259 discloses an OCB LCD, wherein the pixel edge area is located at the boundary of two pixels. Because liquid crystal in the pixel edge area is dominated by two fringe fields, the liquid crystal distribution is unstable and transition is speeded up. The protrusion is disposed on the lower substrate to stabilize the tilt direction of liquid crystal molecules using the fringe effect.

FIG. 2 is a cross section of another conventional OCB mode liquid crystal display device. The OCB mode liquid crystal display device includes a first substrate 220 and a second substrate 210 disposed oppositely to each other. The first substrate 220 and the second substrate 210 are spaced apart by a predetermined gap. The first substrate 220 is an active matrix substrate having data lines 221 and active elements 222 such as thin film transistors. A bump structure 226 is formed on each of the active elements 222. A pixel electrode 225 is formed on the first substrate 220 to connect to each of the active elements 222. A first alignment layer 241 rubbed along a rubbing direction R is formed on the first substrate 220 so that the liquid crystal molecules tilt under the anchoring force of the surface of the first alignment layer 241 after rubbing.

The second substrate 210, a color filter substrate, has a plurality of color filter layers 203, in which each layer aligns with a corresponding sub-pixel. A black matrix 202 is interposed between the neighboring color filter layers 203. A common electrode 204 is formed on the color filter layer 203 and the black matrix 202. A second alignment layer 242 is disposed on the common electrode 204 of the second substrate 210 so that the liquid crystal molecules tilt under the anchoring force of the surface of the second alignment layer 242 after rubbing. A liquid crystal layer 230 is filled in the space between first substrate 220 and the second substrate 210. The pre-tilt angles of liquid crystal molecules 232 within the panel are changed according to added bumps, such as bumps 226 on the active elements 222 and the data lines 221 of the lower substrate. As a result, transition time can be significantly reduced.

Moreover, a method for changing pixel-driving to improve transmittance by observing S-B (splay-to bend) transition has been disclosed in the prior art. For example, an OCB mode liquid crystal display device to improve brightness is disclosed by Samsung at Society for Information Display (SID) in 2006. When observing a graph of voltage vs. transmittance of the OCB mode liquid crystal display device, it can be seen that brightness is effectively increased by 20%. Furthermore, an LCD is disclosed by Chunghwa PictureTubes, LTD. at SID 2006, in which transmittance and contrast of the LCD is improved by changing rubbing angle.

In addition, U.S. Pat. No. 6,927,825 discloses an OCB mode liquid crystal display device in which an interval between pixel regions is set to be smaller to increase transition speed from splay state to bend state. Also, the pre-tilt angle of a liquid crystal molecule is set to be 1.2 to 3 degrees for accelerating response time and brightness.

There are, however, still problems regarding the transmittance of OCB mode liquid crystal display devices. Thus, a need to develop an improved OCB mode liquid crystal display device exists.

### BRIEF SUMMARY OF THE INVENTION

An embodiment of an OCB mode liquid crystal display device is provided. The OCB mode liquid crystal display device comprises a first substrate, a second substrate and a liquid crystal layer interposed therebetween. The first substrate and the second substrate are disposed oppositely to each other. A first pixel electrode is disposed on the first substrate, and a second pixel electrode is disposed on the first substrate and spaced apart from the first pixel electrode by a distance. The first pixel electrode and second pixel electrode are alternately arranged. A first alignment layer disposed on the first substrate covers the first pixel electrode and the second pixel electrode. A common electrode is disposed on the second substrate, and a second alignment layer disposed on the second substrate covers the common electrode.

Another embodiment of an OCB mode liquid crystal display device is also provided. The OCB mode liquid crystal display device comprises a first substrate, a second substrate and a liquid crystal layer interposed therebetween. The first substrate and the second substrate are disposed oppositely to each other. A first pixel electrode is disposed on the first substrate, and a second pixel electrode is disposed on the first pixel electrode. A dielectric layer is interposed between the first pixel electrode and the second pixel electrode, wherein the second pixel electrode comprises a rectangular shape, square shape, V-shaped, bent shape, or circular shape. A first alignment layer is disposed on the first substrate covering the first pixel electrode and the second pixel electrode. A common electrode is disposed on the second substrate, and a second alignment layer is disposed on the second substrate covering the common electrode.

### BRIEF DESCRIPTION OF THE DRAWINGS

The present invention can be more fully understood by reading the subsequent detailed description and examples with references made to the accompanying drawings, wherein:

FIG. 1 is a cross section of a conventional OCB mode liquid crystal display device;

FIG. 2 is a cross section of another conventional OCB mode liquid crystal display device;

FIG. 3a and FIG. 3b are top views showing an exemplary OCB mode liquid crystal display devices of the invention;

FIG. 4a is a cross section taken along I-I′ line of FIG. 3a;

FIG. 4b is a cross section of yet another exemplary OCB mode liquid crystal display device of the invention;

FIG. 5 is a schematic diagram showing the distribution of liquid crystal molecules within an exemplary OCB mode liquid crystal display device of the invention;

FIG. 6a is a graph of transmittance along the direction perpendicular to the longitudinal direction of the tooth parts of the pixel electrodes of a conventional OCB mode liquid crystal display device;

FIG. 6b is a graph of transmittance along the direction perpendicular to the longitudinal direction of the tooth parts of the pixel electrodes of the OCB mode liquid crystal display device of FIG. 5;

FIG. 7 is a graph of transmittance vs. response time of the OCB mode liquid crystal display device of FIG. 5;

FIG. 8a and FIG. 8b are top views showing an exemplary OCB mode liquid crystal display device, in which the first pixel electrode includes a V-shaped part;

FIG. 9a and FIG. 9b are top views showing another exemplary OCB mode liquid crystal display device, in which the first pixel electrode includes a rectangular part;

FIG. 10a and FIG. 10b are top views showing yet another exemplary OCB mode liquid crystal display device, in which the first pixel electrode includes a bent part;

FIG. 11a and FIG. 11b are top views showing still another exemplary OCB mode liquid crystal display device, in which the first pixel electrode includes a circular part; and

FIG. 12 is a flow chart showing an exemplary method for manufacturing an OCB mode liquid crystal display device of invention.

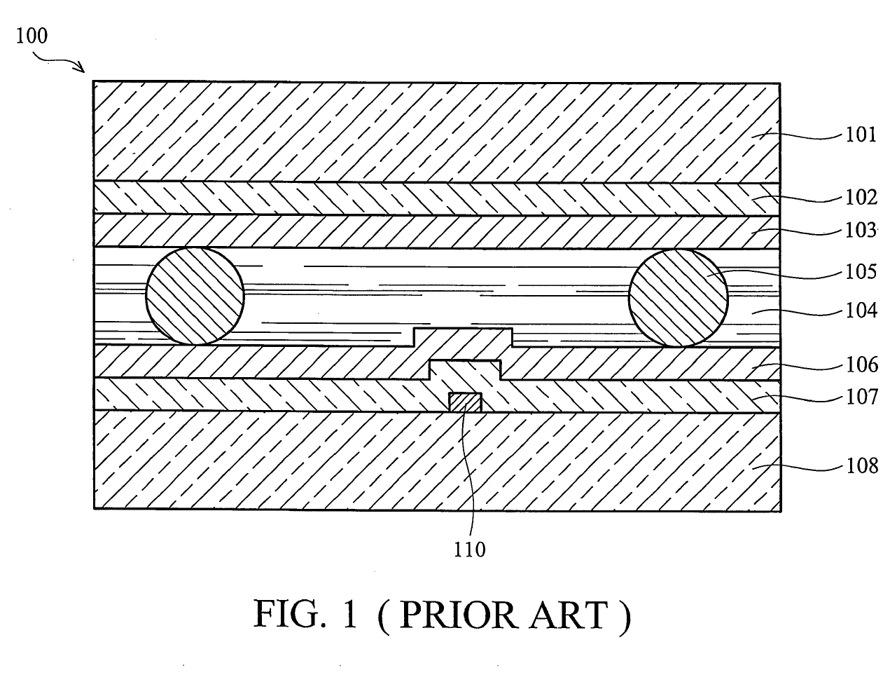

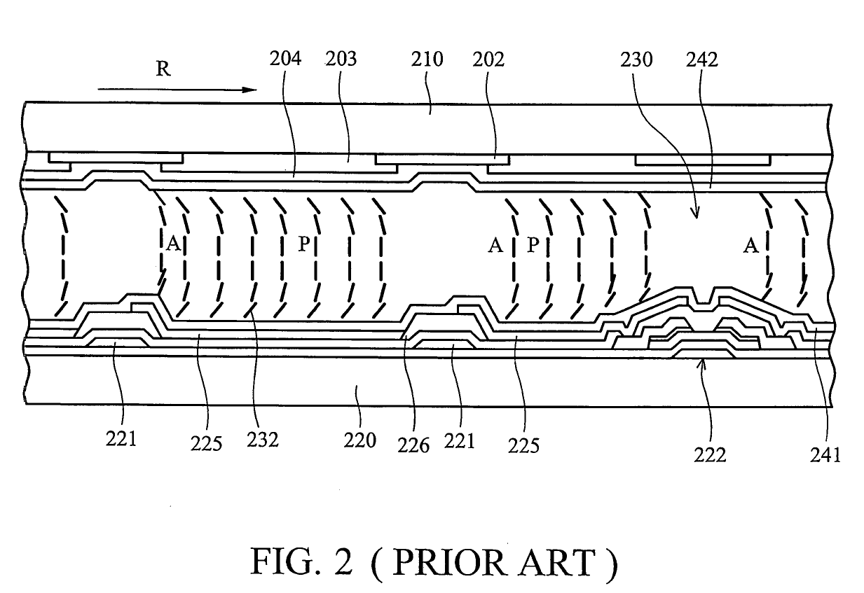

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

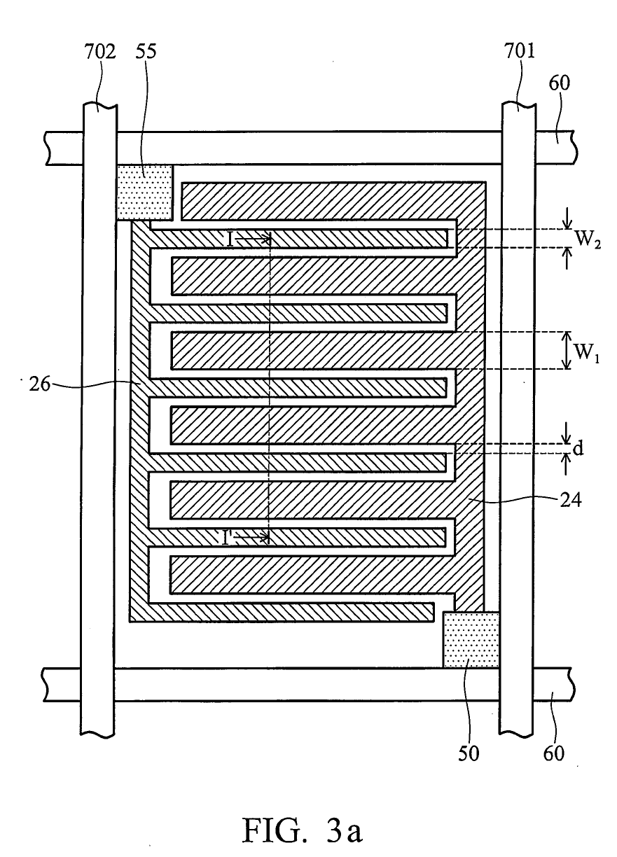

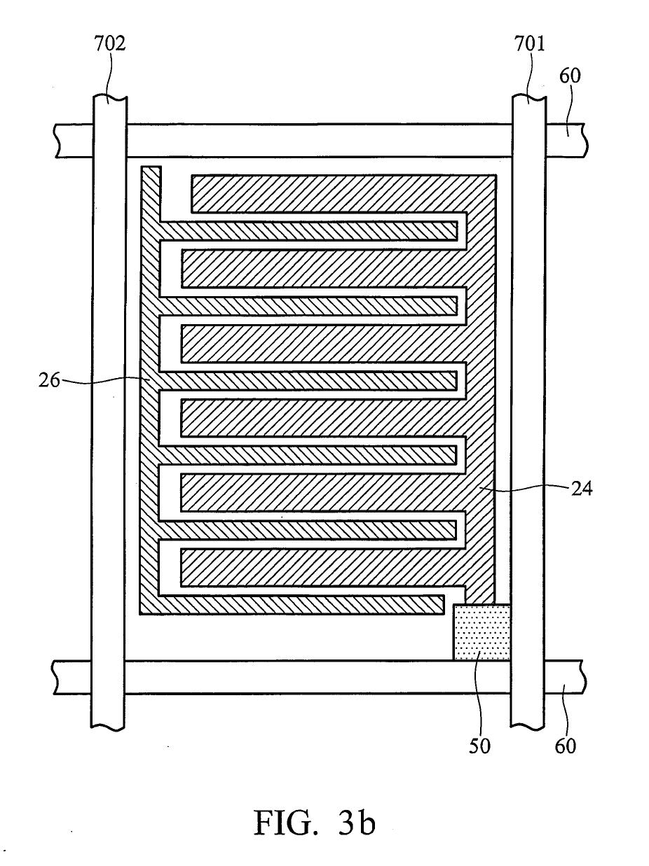

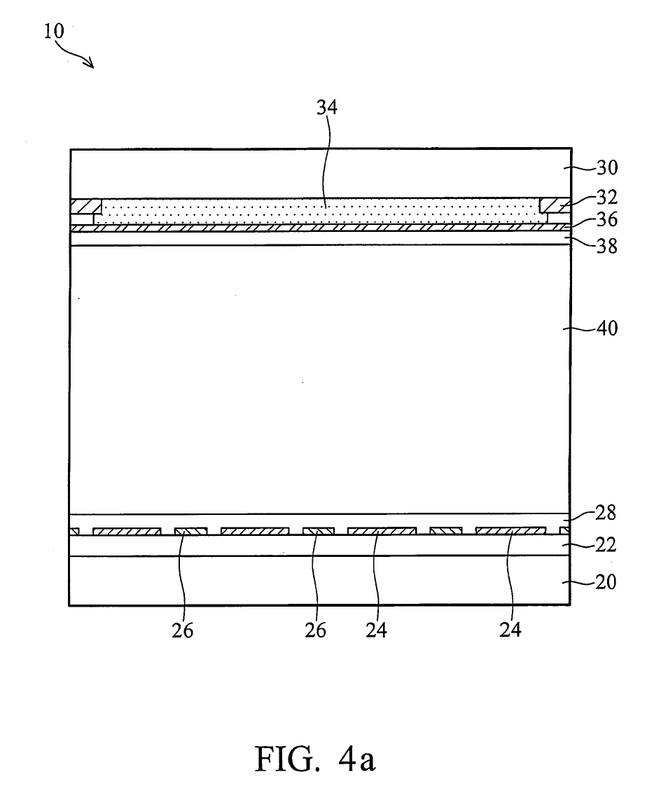

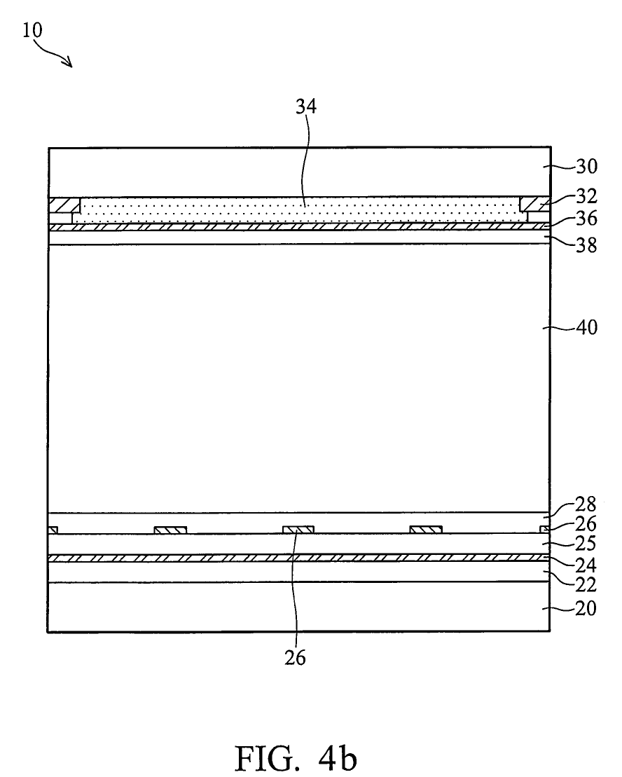

FIG. 3a and FIG. 3b are top views showing a single pixel unit of an OCB mode liquid crystal display device. FIG. 4a is a cross section taken along I-I′ line of FIG. 3a.

Referring to FIG. 4a, an OCB mode liquid crystal display device 10 comprises a first substrate 20, a second substrate 30 and a liquid crystal layer 40 interposed therebetween. The first substrate 20 and the second substrate 30 are disposed oppositely to each other. The first substrate 20 is a so-called active matrix substrate having a thin film transistor array and the second substrate 30 is color filter substrate having a color filter layer 34 and a black matrix 32. The OCB mode liquid crystal display device 10 further comprises a first pixel electrode 24 and a second pixel electrode 26 both formed on the first substrate 20. A dielectric layer 22, for example silicon oxide or silicon nitride, is disposed between the first substrate 20 and the first pixel electrode 24 or the second pixel electrode 26 so that the first pixel electrode 24 and the second pixel electrode 26 are coplanar and disposed on the dielectric layer 22.

The first pixel electrode 24 and the second pixel electrode 26 both are comb-shaped having tooth parts and are alternately arranged. The first pixel electrode 24 is spaced apart from the second pixel electrode 26 by a distance d. The first pixel electrode 24 is applied with a first voltage while the second pixel electrode 26 is applied with a second voltage so that lateral electric fields are generated in the edges of the first pixel electrode and the second pixel electrode. The liquid crystal molecules in the liquid crystal layer 40 laterally tilt under the lateral electric fields and at anchoring force of a rubbed alignment layer to be described later. The lateral tilt angle may increase to improve the transmittance of a liquid crystal display device. Preferably, the first voltage is a driving voltage and the second voltage is fixed voltage (dark state voltage, liquid crystal molecules rise) and the first voltage is less than or equal to the second voltage. If the first pixel electrode 24 and the second pixel electrode 26 are applied different voltages in bright state, transmittance may be increased. Meanwhile, if the first pixel electrode and the second pixel electrode are applied the same voltage, dark-state light leakage may be prevented.

As shown in FIG. 3a, a first thin film transistor 50 is formed on the first substrate 20 inside of a pixel unit for applying the first voltage to the first pixel electrode 24. The first thin film transistor 50 comprises a gate electrode (not shown) connected to a horizontal scan line 60, a source electrode connected a vertical data line 701 and a drain electrode connected to the first pixel electrode 24. Furthermore, a second thin film transistor 55 is formed on the first substrate 20 inside of the same pixel unit for applying the second voltage to the second pixel electrode 26. The second thin film transistor 55 comprises a gate electrode (not shown) connected to a horizontal scan line 60, a source electrode connected a vertical data line 702 and a drain electrode connected to the second pixel electrode 26.

As shown in FIG. 3b, the OCB mode liquid crystal display device of FIG. 3b is substantially similar to that of FIG. 3a, except that the second pixel electrode 26 is applied with the second voltage by a switching element such as a thin film transistor or a power line outside of the pixel unit.

Furthermore, OCB mode liquid crystal display device 10 further comprises a first alignment layer 28 disposed on the first substrate 20 to cover the first pixel electrode 24 and second pixel electrode 26 and fill the space between first pixel electrode 24 and second pixel electrode 26. A common electrode 36 and a second alignment layer 38 covering the common electrode 36 are formed on the second substrate 30.

Moreover, in the OCB mode liquid crystal display device 10 shown in FIG. 3a, the tooth part width W1 of the first pixel electrode 24 is about 1˜120 μm, and the tooth part width W2 of the second pixel electrode 26 is about 1˜40 μm. The tooth part distance d between the first pixel electrode 24 and the second pixel electrode 26 is about 1˜20 μm. In an embodiment of the invention, d:W2:W1 is preferably 1:2:6.

The first alignment layer 28 has a first rubbing direction and the second alignment layer 38 has a second rubbing direction, in which the first rubbing direction and the second rubbing direction have an included angle between 0 and 20 degrees. The first pixel electrode 24 and the second pixel electrode 26 are respectively comb-shaped having tooth parts. The tooth parts of the first pixel electrode 24 are substantially parallel to the tooth parts of the second pixel electrode 26, and a longitudinal direction of each of the tooth parts and the first rubbing direction have an included angle between 0 and 20 degrees. Preferably, the longitudinal direction of each of the tooth parts and the rubbing direction are parallel.

FIG. 4b is a cross section of another exemplary OCB mode liquid crystal display device of the invention. The configuration and operation method for the OCB mode liquid crystal display device of FIG. 4b are substantially similar to those of FIG. 4a except for the arrangements of the first pixel electrode 24 and the second pixel electrode 26. Namely, a first pixel electrode 24 is disposed on the first substrate 20 with a dielectric layer 22 thereon. A dielectric layer 25 is covered on the first pixel electrode 24. A second pixel electrode 26 is then formed on the dielectric layer 25. It is noted that the first pixel electrode 24 is entirely formed on the pixel area of a pixel unit. The shape and arrangement of the second pixel electrode 26 are the same as those of the OCB mode liquid crystal display device as shown in FIG. 4a. The tooth part width of the second pixel electrode 26 is about 1˜40 μm, and the space between the neighboring tooth parts is about 1˜250 μm.

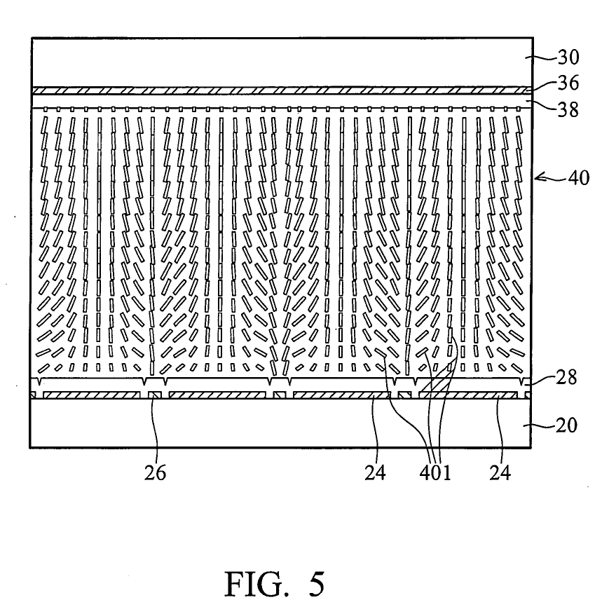

FIG. 5 is a schematic diagram showing the distribution of liquid crystal molecules within an exemplary OCB mode liquid crystal display device of the invention, in which the tooth part width W1 of the first pixel electrode 24 in is about 1˜120 μm, and the tooth part width W2 of the second pixel electrode 26 is about 1˜40 μm. The tooth part distance d between the first pixel electrode 24 and the second pixel electrode 26 is about 1˜20 μm. A positive liquid crystal material having high dielectric anisotropy and lower viscosity is used. The rubbing direction of the first alignment layer 28 and the longitudinal direction of each of the tooth parts have an included angle between 0 and 20 degrees. The second alignment layer 38 and the first alignment layer 28 have substantially the same rubbing direction. The first pixel electrode 24 and the second pixel electrode 26 can be applied with different voltages. Therefore, the liquid crystal molecules 401 near the first substrate 20 have relatively greater pre-tilt angles than the liquid crystal molecules 401 near the second substrate 30 in bright state, thus increasing viewing angle and improving light transmittance.

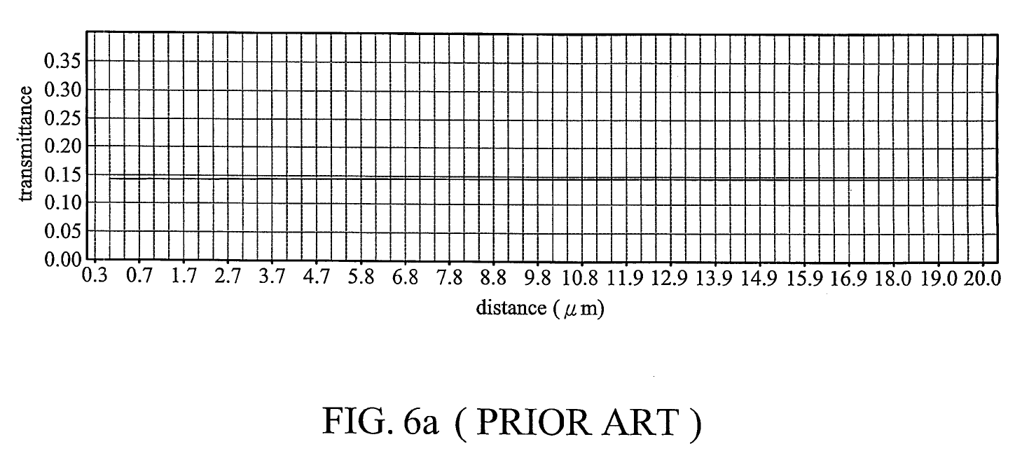

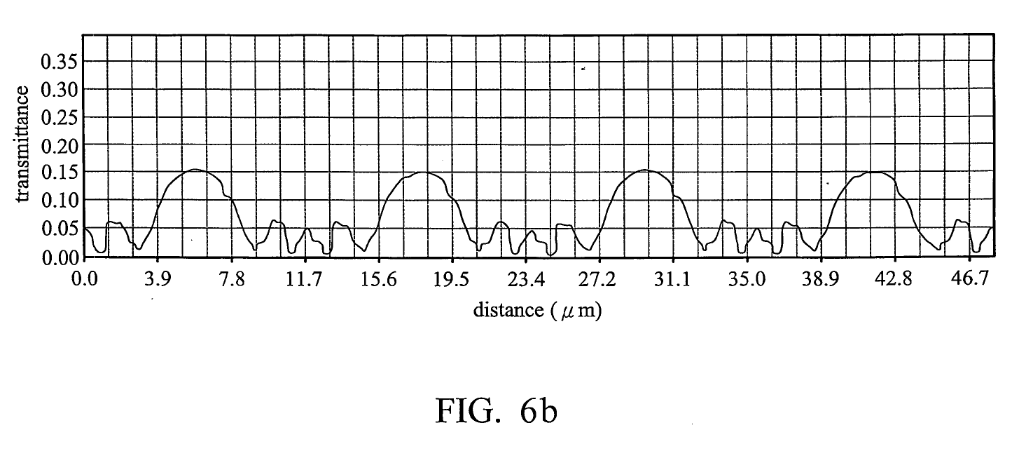

FIG. 6b is a graph of transmittance along the direction perpendicular to the longitudinal direction of the tooth parts of the pixel electrodes of the OCB mode liquid crystal display device of FIG. 5. FIG. 6a is a graph of transmittance along the direction perpendicular to the longitudinal direction of the tooth parts of the pixel electrodes of a conventional OCB mode liquid crystal display device having one pixel electrode and one thin film transistor in each pixel unit.

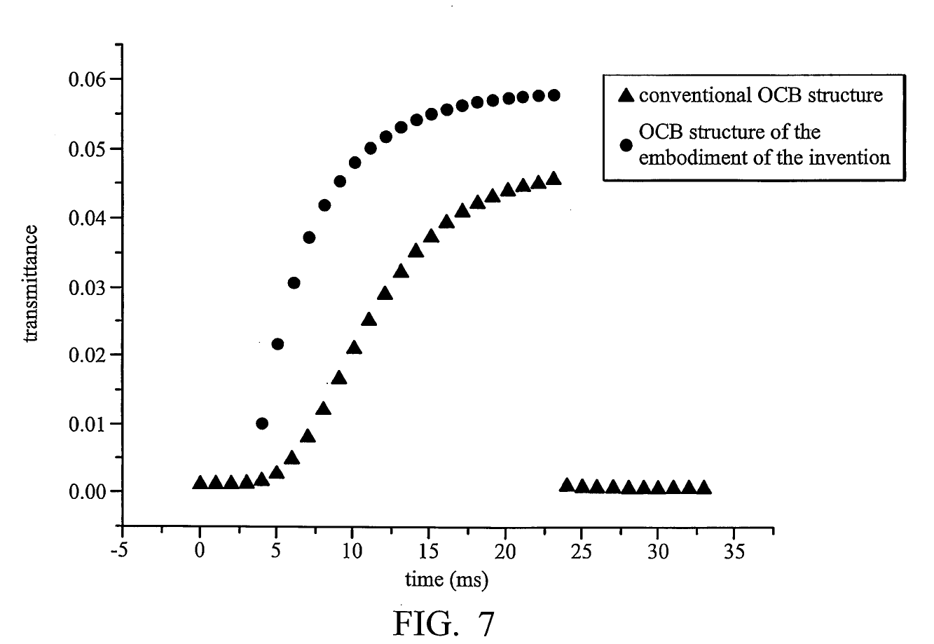

FIG. 7 is a graph of response time of the OCB mode liquid crystal display device of FIG. 5. As shown in FIG. 7, the response time of the OCB mode liquid crystal display device of an embodiment of the invention is similar to that of the conventional OCB mode liquid crystal display device. The transmittance of the embodiment of the invention is greater than that of the conventional device.

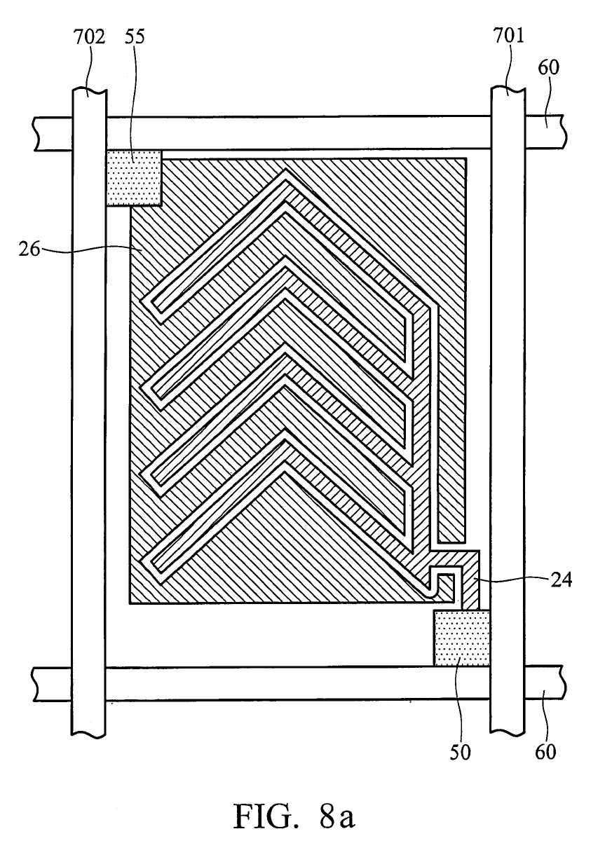

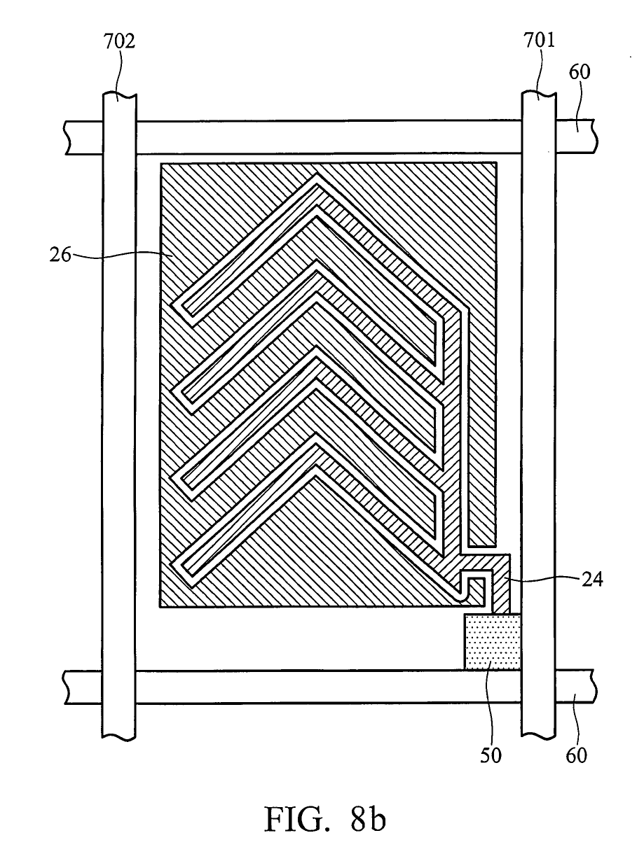

FIG. 8a and FIG. 8b are top views showing an exemplary OCB mode liquid crystal display device, in which the first pixel electrode 24 includes a V-shaped part. The OCB mode liquid crystal display device shown in FIG. 8a includes a first thin film transistor 50 and a second thin film transistor 55 in one pixel unit. The first pixel electrode 24 and the second pixel electrode 26 are applied a first voltage and a second voltage respectively by the first thin film transistor 50 and the second thin film transistor 55. The OCB mode liquid crystal display device shown in FIG. 8b only includes a first thin film transistor 50 for applying the first voltage to first pixel electrode 24. The second pixel electrode 26 is applied with the second voltage by a switching element or a power line outside of the pixel unit.

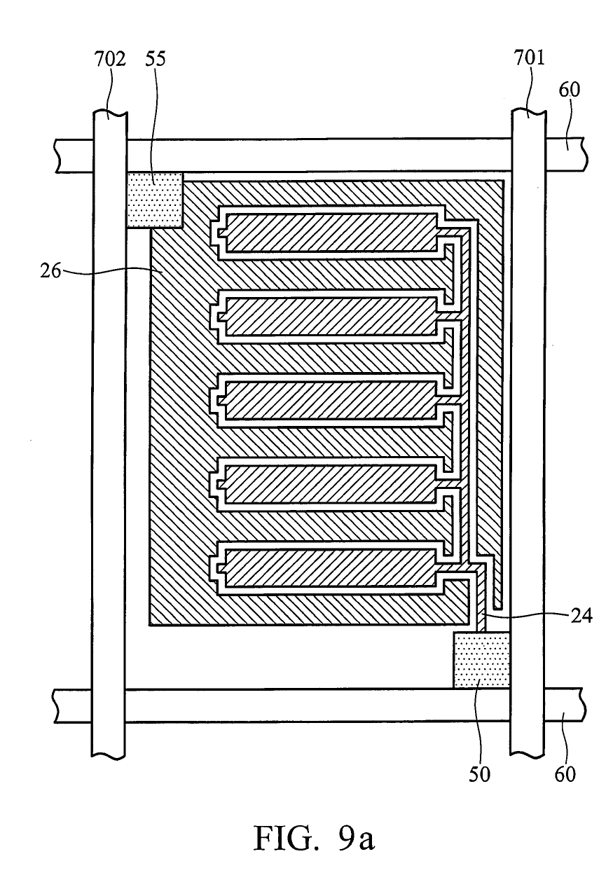

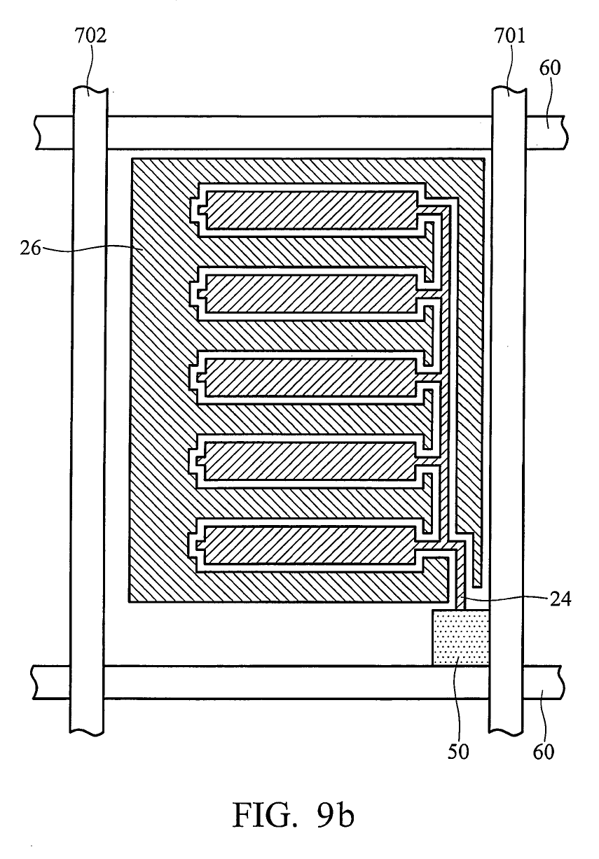

FIG. 9a and FIG. 9b are top views showing another exemplary OCB mode liquid crystal display device, in which the first pixel electrode 24 includes a rectangular part. The OCB mode liquid crystal display device shown in FIG. 9a includes a first thin film transistor 50 and a second thin film transistor 55 in one pixel unit. The first pixel electrode 24 and the second pixel electrode 26 are applied a first voltage and a second voltage respectively by the first thin film transistor 50 and the second thin film transistor 55. The OCB mode liquid crystal display device shown in FIG. 9b only includes a first thin film transistor 50 for applying the first voltage to first pixel electrode 24. The second pixel electrode 26 is applied with the second voltage by a switching element or a power line outside of the pixel unit.

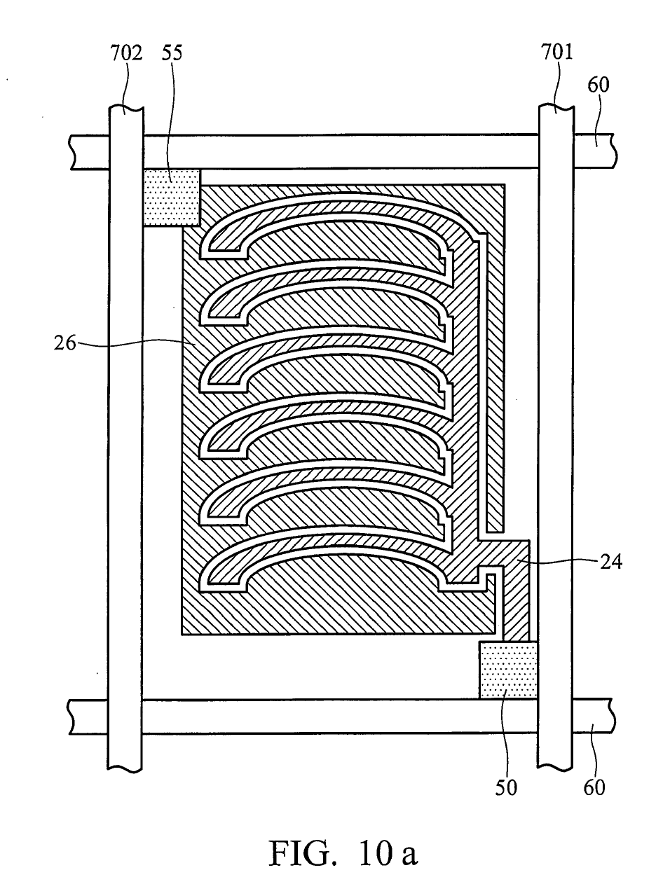

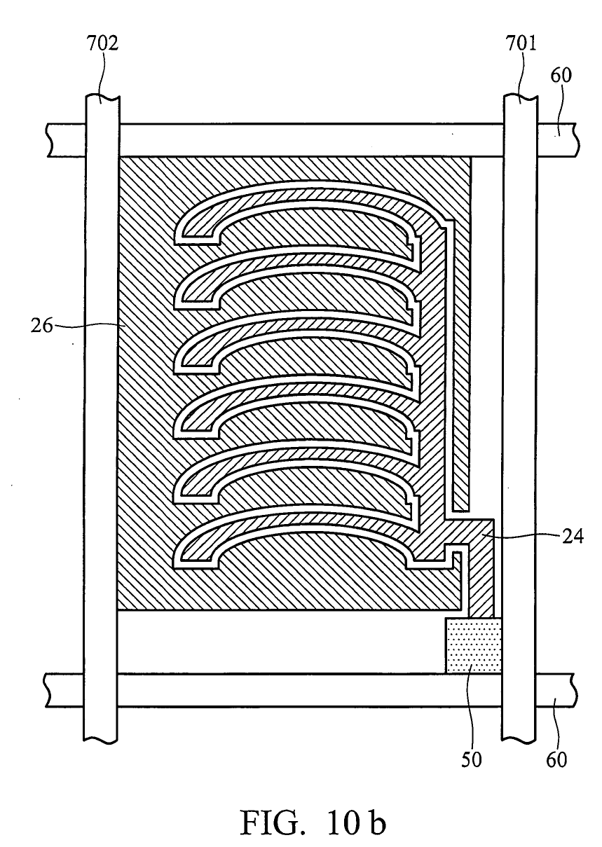

FIG. 10a and FIG. 10b are top views showing yet another exemplary OCB mode liquid crystal display device, in which the first pixel electrode 24 includes a bent part. The OCB mode liquid crystal display device shown in FIG. 10a includes a first thin film transistor 50 and a second thin film transistor 55 in one pixel unit. The first pixel electrode 24 and the second pixel electrode 26 are applied a first voltage and a second voltage respectively by the first thin film transistor 50 and the second thin film transistor 55. The OCB mode liquid crystal display device shown in FIG. 10b only includes a first thin film transistor 50 for applying the first voltage to first pixel electrode 24. The second pixel electrode 26 is applied with the second voltage by a switching element or a power line outside of the pixel unit.

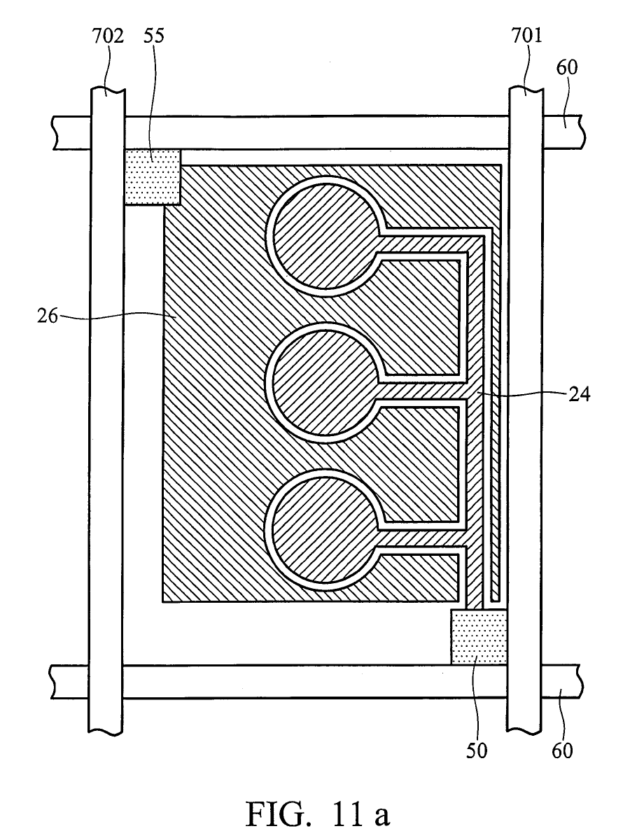

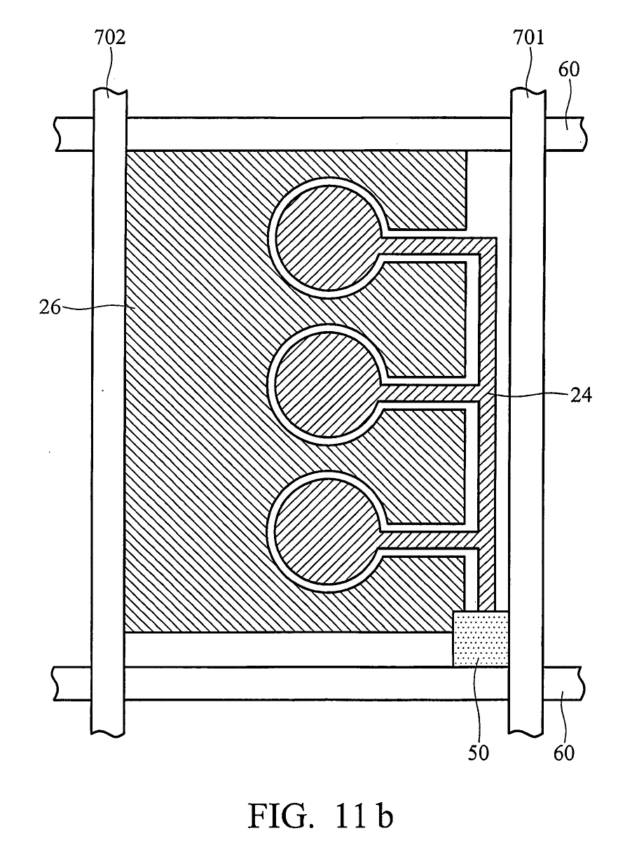

FIG. 11a and FIG. 11b are top views showing still another exemplary OCB mode liquid crystal display device, in which the first pixel electrode 24 includes a circular part. The OCB mode liquid crystal display device shown in FIG. 11a includes a first thin film transistor 50 and a second thin film transistor 55 in one pixel unit. The first pixel electrode 24 and the second pixel electrode 26 are applied a first voltage and a second voltage respectively by the first thin film transistor 50 and the second thin film transistor 55. The OCB mode liquid crystal display device shown in FIG. 11b only includes a first thin film transistor 50 for applying the first voltage to first pixel electrode 24. The second pixel electrode 26 is applied with the second voltage by a switching element or a power line outside of the pixel unit.

In one embodiment of the invention, a common electrode 36 may comprise a whole shape, rectangular shape, square shape, V-shape, bent shape, circular shape or other patterned shapes.

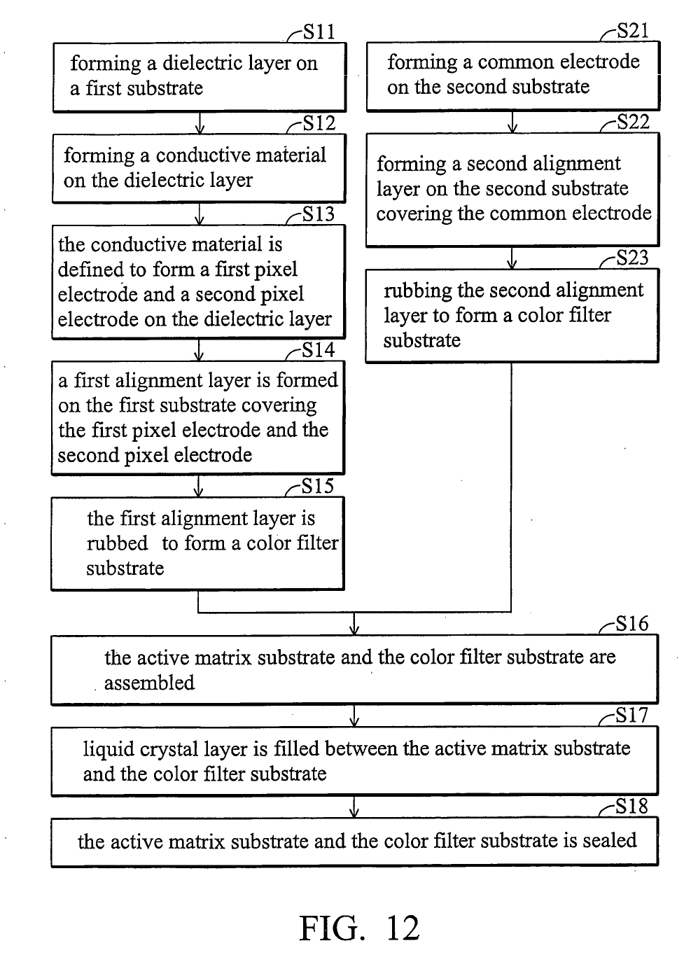

FIG. 12 is a flow chart showing an exemplary method for manufacturing an OCB mode liquid crystal display device of invention. The method for manufacturing an OCB mode liquid crystal display device comprises forming a dielectric layer on a first substrate (S11) and forming a conductive material on the dielectric layer (S12). The conductive material may comprise a transparent material such as indium tin oxide (ITO) or indium zinc oxide (IZO). Next, in step S13, the conductive material is defined to form a first pixel electrode and a second pixel electrode on the dielectric layer, in which the first pixel electrode and the second pixel electrode is alternately arranged and spaced a distance apart. Then, in step S14, a first alignment layer is formed on the first substrate covering the first pixel electrode and the second pixel electrode. Next, in step S15, the first alignment layer is rubbed to form an active matrix substrate having thin film transistors, data lines and scan lines.

Meanwhile, the steps for manufacturing a color filter substrate comprises forming a common electrode on the second substrate (S21), forming a second alignment layer on the second substrate covering the common electrode (S22) and rubbing the second alignment layer (S23). The color filter substrate further comprises a color filter layer and black matrix resist layer thereon.

Next, in step S16, the active matrix substrate (including the first substrate) and the color filter substrate (including the second substrate) are assembled. A liquid crystal layer is then filled between the active matrix substrate and the color filter substrate in step S17. Then, in step S18, the active matrix substrate and the color filter substrate are sealed.

In another embodiment of the invention, step S12 may comprise four sub-steps.

The sub-steps, in sequence, are (a) defining the conductive layer to form a first pixel electrode completely disposed on the pixel area of the pixel unit, (b) forming an additional dielectric layer on the first pixel electrode, (c) forming an additional conductive material on the additional dielectric layer, and (d) defining the additional conductive material to form a second pixel electrode having a predetermined shape such as rectangular shape, square shape, V-shaped, bent shape or circular shape.

According to embodiments of the OCB mode liquid crystal display device and methods for manufacturing the same of the invention, the viewing angle and transmittance can be improved. Additionally, response time and state transition time may be reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optically compensated bend mode liquid crystal display device, comprising:
a first substrate, a second substrate and a liquid crystal layer interposed therebetween, wherein the first substrate and the second substrate are disposed oppositely to each other;
a first pixel electrode disposed on the first substrate;
a second pixel electrode disposed on the first substrate and spaced apart from the first pixel electrode by a distance, and the first pixel electrode and the second pixel electrode are alternately arranged;
a first alignment layer disposed on the first substrate covering the first pixel electrode and the second pixel electrode;
a common electrode disposed on the second substrate; and
a second alignment layer disposed on the second substrate covering the common electrode.

2. The optically compensated bend mode liquid crystal display device as claimed in claim 1, wherein the first pixel electrode is applied with a first voltage while the second pixel electrode is applied with a second voltage, and lateral electric fields are generated in edges of the first pixel electrode and the second pixel electrode.

3. The optically compensated bend mode liquid crystal display device as claimed in claim 2, wherein the first voltage is less than or equal to the second voltage.

4. The optically compensated bend mode liquid crystal display device as claimed in claim 2, wherein the first voltage is a driving voltage and the second voltage is a fixed voltage.

5. The optically compensated bend mode liquid crystal display device as claimed in claim 2, further comprising:
a first thin film transistor formed on the first substrate for applying the first voltage to the first pixel electrode; and
a second thin film transistor or a power line for applying the second voltage to the second pixel electrode.

6. The optically compensated bend mode liquid crystal display device as claimed in claim 5, wherein the first thin film transistor is formed inside of a pixel unit and the second thin film transistor is formed inside of the pixel unit.

7. The optically compensated bend mode liquid crystal display device as claimed in claim 5, the first thin film transistor is formed inside of a pixel unit and the second thin film transistor or the power line is formed outside of the pixel unit.

8. The optically compensated bend mode liquid crystal display device as claimed in claim 1, wherein the first pixel electrode and the second pixel electrode comprise a rectangular shape, square shape, V-shape, bent shape, or circular shape.

9. The optically compensated bend mode liquid crystal display device as claimed in claim 1, the common electrode comprises a whole shape, rectangular shape, square shape, V-shape, bent shape, or circular shape.

10. The optically compensated bend mode liquid crystal display device as claimed in claim 1, the first alignment layer has a first rubbing direction and the second alignment layer has a second rubbing direction.

11. The optically compensated bend mode liquid crystal display device as claimed in claim 10, wherein the first rubbing direction and the second rubbing direction have an included angle between 0 and 20 degrees.

12. The optically compensated bend mode liquid crystal display device as claimed in claim 10, wherein the first pixel electrode and the second pixel electrode are comb-shaped having tooth parts, and a longitudinal direction of each of the tooth parts and the first rubbing direction have an included angle between 0 and 20 degrees.

13. The optically compensated bend mode liquid crystal display device as claimed in claim 1, further comprising a dielectric layer disposed between the first pixel electrode and the first substrate, and between the second pixel electrode and the first substrate.

14. The optically compensated bend mode liquid crystal display device as claimed in claim 13, wherein the first pixel electrode and the second pixel electrode are coplanar.

15. The optically compensated bend mode liquid crystal display device as claimed in claim 1, wherein the first alignment layer is filled between the first pixel electrode and the second pixel electrode.

16. An optically compensated bend mode liquid crystal display device, comprising:
a first substrate, a second substrate and a liquid crystal layer interposed therebetween, wherein the first substrate and the second substrate are disposed oppositely to each other;
a first pixel electrode disposed on the first substrate;
a second pixel electrode disposed on the first pixel electrode, wherein the second pixel electrode comprises a rectangular shape, square shape, V-shape, bent shape, or circular shape;
a dielectric layer disposed interposed between the first pixel electrode and the second pixel electrode;
a first alignment layer disposed on the first substrate covering the first pixel electrode and the second pixel electrode;
a common electrode disposed on the second substrate; and
a second alignment layer disposed on the second substrate covering the common electrode.

17. The optically compensated bend mode liquid crystal display device as claimed in claim 16, wherein the first pixel electrode is applied with a first voltage while the second pixel electrode is applied with a second voltage.

18. The optically compensated bend mode liquid crystal display device as claimed in claim 17, wherein the first voltage is less than or equal to the second voltage.

19. The optically compensated bend mode liquid crystal display device as claimed in claim 17, wherein the first voltage is a driving voltage and the second voltage is a fixed voltage.

20. The optically compensated bend mode liquid crystal display device as claimed in claim 17, further comprising:
a first thin film transistor formed on the first substrate for applying the first voltage to the first pixel electrode; and
a second thin film transistor formed on the first substrate for applying the second voltage to the second pixel electrode.

21. The optically compensated bend mode liquid crystal display device as claimed in claim 20, wherein the first thin film transistor is formed inside of a pixel unit and the second thin film transistor is formed inside of the pixel unit.

22. The optically compensated bend mode liquid crystal display device as claimed in claim 20, the first thin film transistor is formed inside of a pixel unit and the second thin film transistor is formed outside of the pixel unit.

23. The optically compensated bend mode liquid crystal display device as claimed in claim 16, wherein the first alignment layer has a first rubbing direction and the second alignment layer has a second rubbing direction.

24. The optically compensated bend mode liquid crystal display device as claimed in claim 23, wherein the first rubbing direction and the second rubbing direction have an included angle between 0 and 20 degrees.

25. The optically compensated bend mode liquid crystal display device as claimed in claim 16, wherein the second pixel electrode are comb-shaped having tooth parts, and a longitudinal direction of each of the tooth parts and the first rubbing direction have an included angle between 0 and 20 degrees.
